(19) United States
(12) Patent Application Publication
(10) Pub. No.: US 2008/0319767 A1
(43) Pub. Date: Dec. 25, 2008

(54) METHOD AND APPARATUS FOR IDENTIFYING DEPENDENCY LOOPS

(75) Inventors: Anette KUBLER, Markt Schwaben (DE); Willfried Wienholt, Munchen (DE)

Correspondence Address: YOUNG & THOMPSON, 209 Madison Street, Suite 500, ALEXANDRIA, VA, 22314, US

(73) Assignee: SIEMENS AKTIENGESELLSCHAFT, MUNCHEN (DE)

(21) Appl. No.: 11/764,815

(22) Filed: Jun. 19, 2007

(51) Int. Cl. G06Q 99/00

(52) U.S. Cl. 705/1

(57) ABSTRACT

An apparatus and a method for identifying dependency loops in an urban development graph (UDG) having nodes each representing an urban development factor (f), wherein the nodes are connected to each other via weighted edges describing dependencies between the nodes, wherein an objective function value is calculated for each loop of the urban development graph (UDG) and the loops are sorted according to the respective calculated objective function values of the loops.

### BACKGROUND OF THE INVENTION

The invention relates to a method and an apparatus for identifying dependency loops, in particular, in an urban development graph.

Urban planning is the discipline of land use planning which explores several aspects of the built and the social environments of municipalities and communities. Sustainable development compasses different areas, such as economic, environmental and social development as well as the government of the community. For each area, several development factors can be identified, such as water quality, waste, transport, health care, communication, safety, security, air, building, infrastructure and recreation areas. Those urban development factors are interdependent from each other. These interdependencies are quite complex and not evident for the developers.

At the moment, there does not exist any tool for developers to analyze interdependencies among development factors.

Accordingly, it is an object of the present invention to provide a method and an apparatus for identifying interdependencies among urban development factors exerting an influence on the development of a community.

### SUMMARY OF THE INVENTION

The invention provides a method for identifying dependency loops in an urban development graph having nodes each representing an urban development factor, wherein said nodes are connected to each other via weighted edges describing dependencies between said nodes, wherein an objective function (OF) is calculated for each loop of said urban development graph and the loops are sorted according to the respective calculated objective functions (OF) of said loops.

In an embodiment of the method according to the present invention, the calculated objective functions (OF) are sorted in descending order.

In an embodiment of the method according to the present invention, the urban development graph is encoded by a urban development link matrix.

In an embodiment of the method according to the present invention, the urban development graph is formed by a directive graph.

In an embodiment of the method according to the present invention, the objective function is selected from a group of predetermined objective functions.

The invention further provides a computer program for identifying dependency loops in an urban development graph having nodes each representing an urban development factor, wherein said nodes are connected to each other via weighted edges describing dependencies between said nodes, wherein an objective function is calculated for each loop of said urban development graph and the loops are sorted according to the respective calculated objective functions of said loop.

The invention further provides a data carrier for storing said computer program.

The invention further provides an apparatus for identifying dependency loops in an urban development graph wherein said apparatus comprises a memory for storing an urban development link matrix representing said urban development graph, and a calculating unit for calculating an objective function for each loop of said urban development graph and for sorting the loop according to the respective calculated objective functions of said loops.

In an embodiment of the apparatus according to the present invention, the apparatus further comprises input means for inputting urban development factors into an urban development link matrix template displayed on a display of said apparatus.

In an embodiment of the apparatus according to the present invention, weighting factors are input via said input means into the urban development link matrix template to generate said urban development link matrix.

In an embodiment of the apparatus according to the present invention, the sorted loops and the corresponding calculated object functions of said loops are displayed on said display.

### BRIEF DESCRIPTION OF THE FIGURES

FIG. 1 shows a block diagram of a possible embodiment of the apparatus according to the present invention.

FIG. 2 shows an example of an urban development link matrix as used by the method and apparatus according to an embodiment of the present invention.

FIG. 3 shows an example of the corresponding urban development graph as used by the method and apparatus according to an embodiment of the present invention.

FIG. 4 shows a further exemplary urban development graph as used by said method and apparatus according to an embodiment of the present invention.

FIG. 5 shows an example of a dependency loop in urban development graphs.

FIG. 6 shows a further example for two different loops within an urban development graph as employed by the apparatus and method according to the present invention.

### DETAILED DESCRIPTION OF THE FIGURES

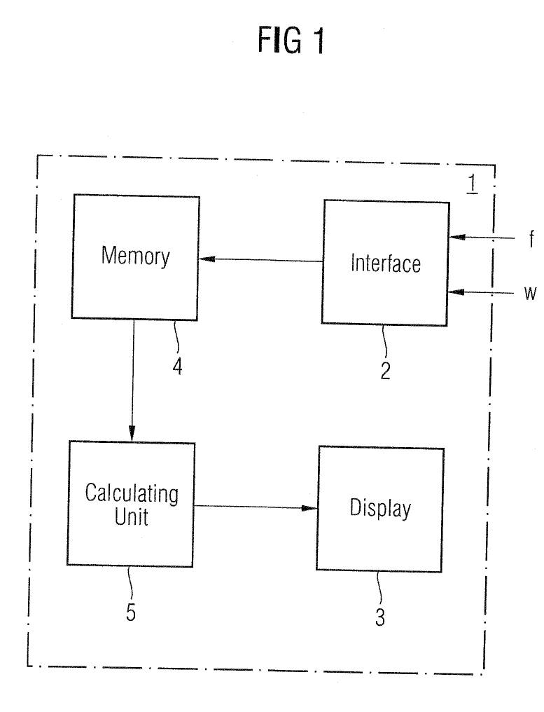

FIG. 1 shows an embodiment of an apparatus 1 for identifying dependency loops in an urban development graph according to the present invention. The apparatus 1 comprises an interface 2 for inputting urban development factors f into an urban development link matrix template displayed on a display 3 of the apparatus 1. Further, weighting factors w are input via said interface 2, such as a keyboard, into the apparatus 1 which generates an urban development link matrix. The generated urban development link matrix UDLM is stored in a memory 4 of the apparatus 1. The calculating unit 5 of the apparatus 1 evaluates the generated urban development link matrix stored in the memory 4. The urban development link matrix represents an urban development graph UDG. The urban development graph UDG comprises nodes each representing an urban development factor f wherein said nodes are connected to each other via weighted edges describing dependencies between said nodes. In an embodiment, an objective function OF is selected by a user from a group of predetermined object functions OF and the calculating unit 5 calculates for each loop of the urban development graph UDG represented by the urban development link matrix UDLM stored in the memory 4 a corresponding objective function value. In a further step, the calculating unit 5 sorts the dependency loops of the urban development graph UDG according to the respective calculated objective function values of the loops.

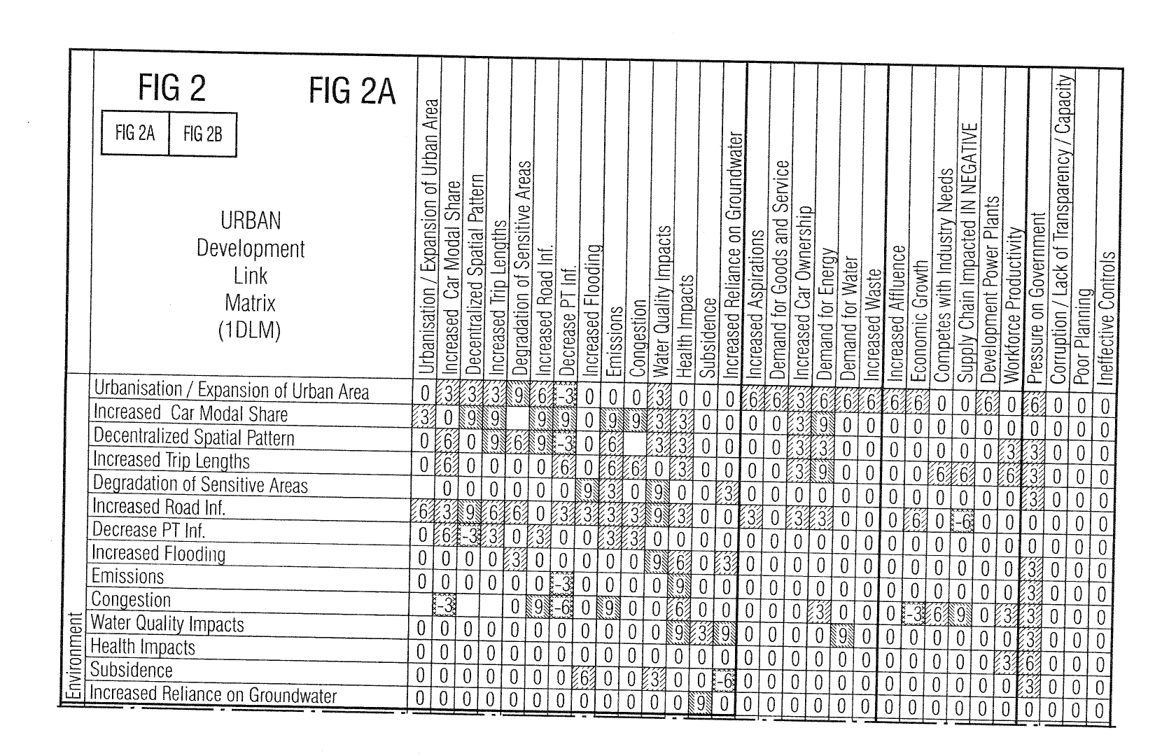

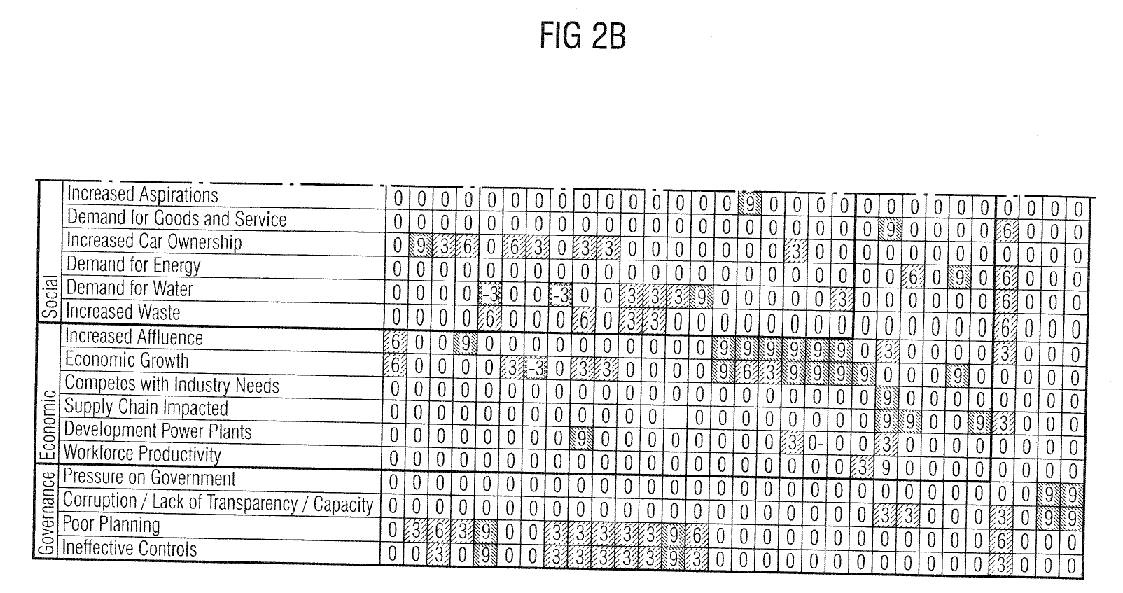

The urban development factors f input by the interface 2 of the apparatus 1 can be any factor having an impact on the sustainable development of an infrastructure. FIG. 2 shows an example for an urban development link matrix UDLM having N factors, i.e. the urban development link matrix UDLM is formed by an N×N matrix having N×N input fields for inputting weighting factors w. In the given example of FIG. 2, the urban development factors f are categorized into four areas, i.e. government, economic, social and environment. Each category or area comprises different urban development factors f. In the given example, the category “governance” comprises the following factors, namely “pressure on government”, “corruption”, “poor planning” and “ineffective controls”. The category “economic” comprises the factors “increased affluence”, “economic growth”, “competer with industry needs”, “supply chain impacted”, “development power plants”, “workforce productivity”. The category “social” comprises the factors “increased aspirations”, “demand for goods and services”, “increased car ownership”, “demand for energy”, “demand for water” and “increased waste”. The category “environment” comprises the factors “urbanization”, “increased car model share”, “decentralized spatial pattern”, “increased trip lengths”, “degradation of sensitive areas”, “increased road”, “decreased PT”, “increased flooding”, “emissions”, “congestions”, “water quality impacts”, “health impacts”, “subsidence” and “increased reliance on ground water”.

These factors f are input in one embodiment by a programmer or user via the interface 2 into an urban development link matrix template. After the definition of the urban development link matrix comprising N×N fields, experts of the respective areas weight the dependency between two factors by inputting weighting factors into the template. In a possible embodiment, weighting factors w ranging from −10 to +10 are input in the fields of the template. In a possible embodiment, the urban development link matrix UDLM is not symmetrical, i.e. a first factor f1 has a different impact on a second factor f2 than the second factor f2 on the first factor f1. In the given example of FIG. 2, a positive weighting factor indicates a positive influence of one factor on another factor.

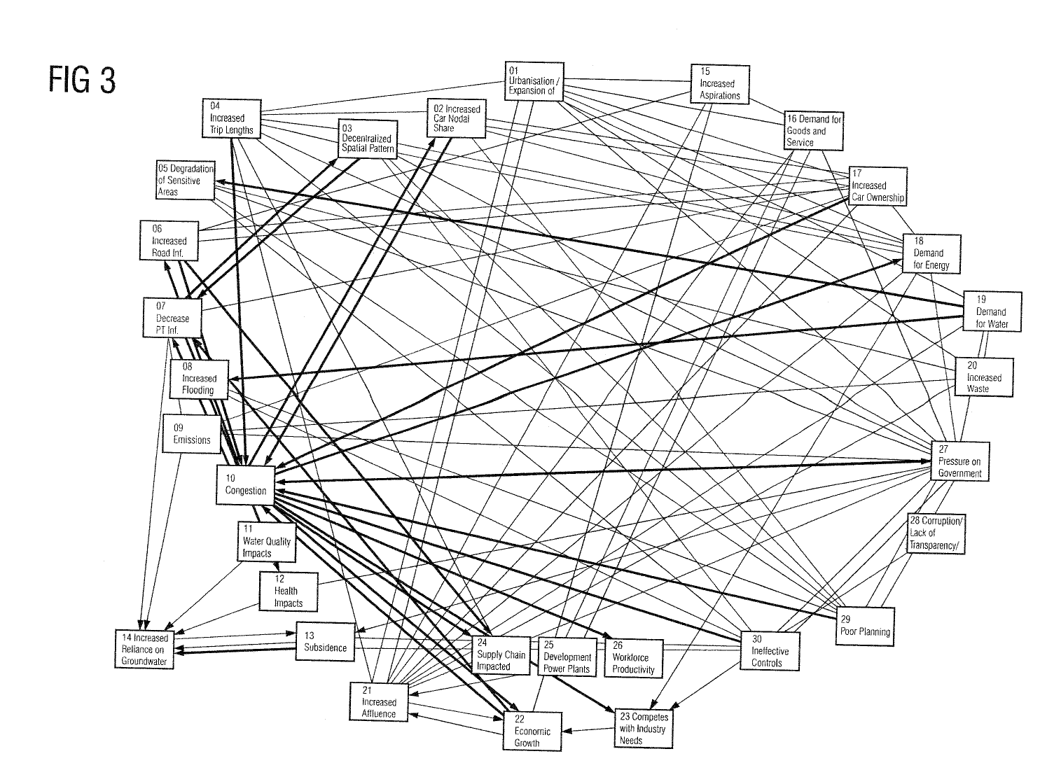

FIG. 3 shows the interdependencies between the urban development factor “congestion” within the category “environment” and other urban development factors, such as “increased car ownership”, “demand for energy” or “economic growth”. As can be seen from the urban development link matrix shown in FIG. 2 or the graph in FIG. 3, an increased congestion decreases the demand for energy expressed by a positive weighting factor “+3” but diminishes the “economic growth” expressed by a negative weighting factor “−3”. The urban development link matrix UDLM as shown in FIG. 2 is stored in the memory 4 of the apparatus 1. On the basis of the urban development link matrix UDLM representing an urban development graph UDG such as shown in FIG. 3, the calculating unit 5 identifies dependency loops in the urban development graph. The calculating unit 5 is formed in one embodiment by a microprocessor. The microprocessor 5 calculates an objective function OF for each loop L of the urban development graph UDG such as shown in FIG. 3, and then sorts the loops L according to the respective calculated objective function value. The sorted loops L are then displayed along with the calculated objective function values on the display 3 of the apparatus 1. In a possible embodiment, the calculated objective function values are sorted in a descending order.

The objective function OF can be chosen by a user from a predetermined group of objective functions. The objective function is calculated in one embodiment as the product of all weighting factors w of the edges connecting all nodes of the closed loop L.

The closed loop L comprises, for instance three nodes which are connected to each other via three edges having weighting factors w₁₂, w₂₃, w₃₁. The objective function OF is given in an embodiment by:

OF=w₁₂·w₂₃·w₃₁.

Another possible objective function OF is formed by the sum of all absolute weighing factors. In the given example, the objective function is:

OF=|w₁₂|+|w₂₃|+|w₃₁|

The objective function OF is selected in a possible embodiment according to a selection criterion input by the user into the interface 2 of the apparatus 1.

In a possible embodiment, the dependency loop L having the highest calculated objective function value is shown at the beginning of a list displayed on a display 3 and the loop with the lowest objective function value is shown last.

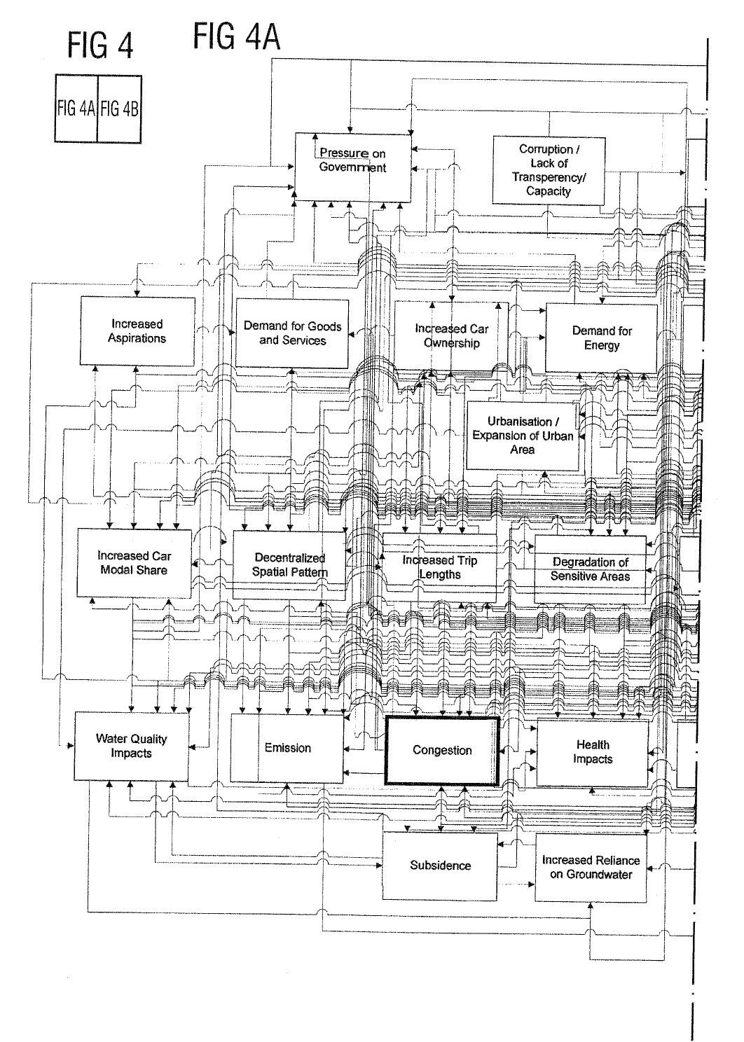

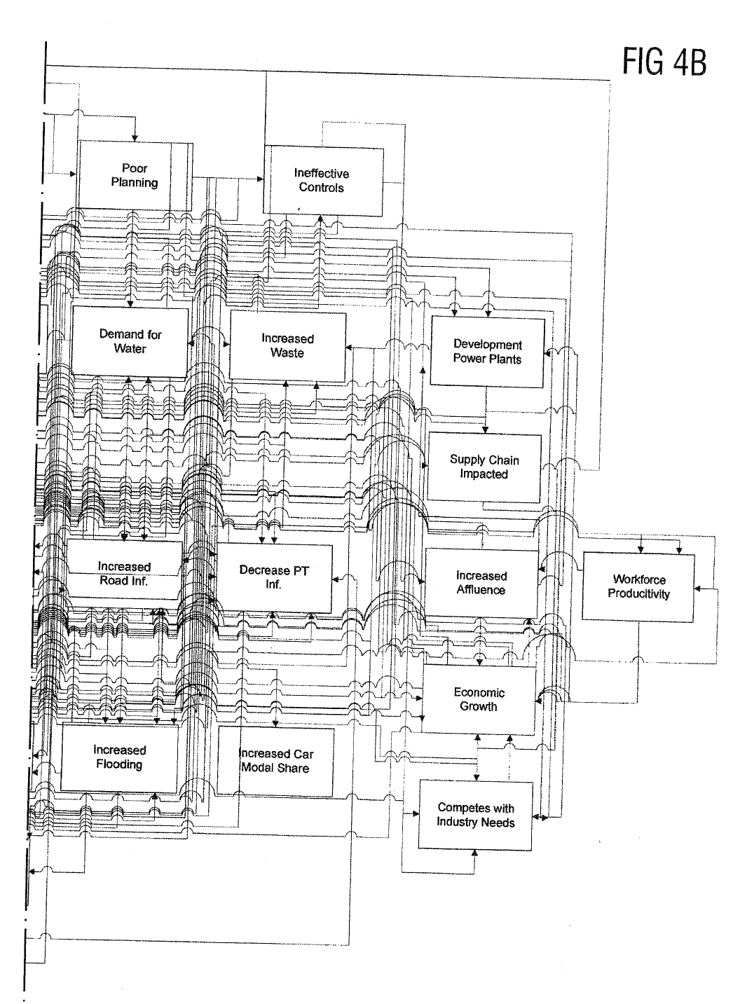

As can be seen from the example of FIG. 4, an urban development graph UDG as used by the apparatus and method according to the present invention can be quite complex so that it is impossible for a user without automatic calculation of the dependency loops L to recognize dependencies between the different factors f.

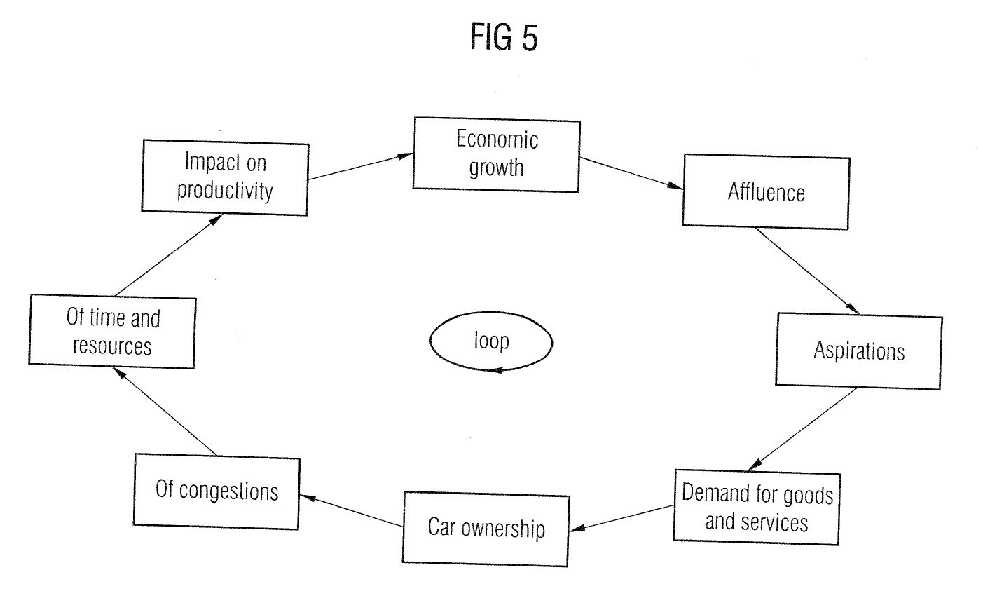

FIG. 5 shows an example for a closed dependency loop L within the field of transportation. The increase of congestions, such as traffic jams lead to a waste of time and resources which in turn have a negative impact on productivity. Because diminishing productivity the economic growth is also diminished having an impact on affluence. With lower affluence, the aspirations are also diminished so that the demand for goods and services becomes lower. This has the effect that the car ownership also goes down so that the traffic jams become less likely. In this manner, self-regulating dependency loops or unstable loops can be identified.

In a possible embodiment, the objective function OF is a measure for the length of a dependency loop. Longer dependency loops illustrate more complex interdependencies which are not evident to the developer. In an embodiment, longer dependency loop having higher objective function values are displayed to the user on the top of a sorted list. In a possible embodiment, the illustrated list is displayed with the objective functions as well as with all the nodes of the corresponding dependency loops L so that they can be further analyzed by the user.

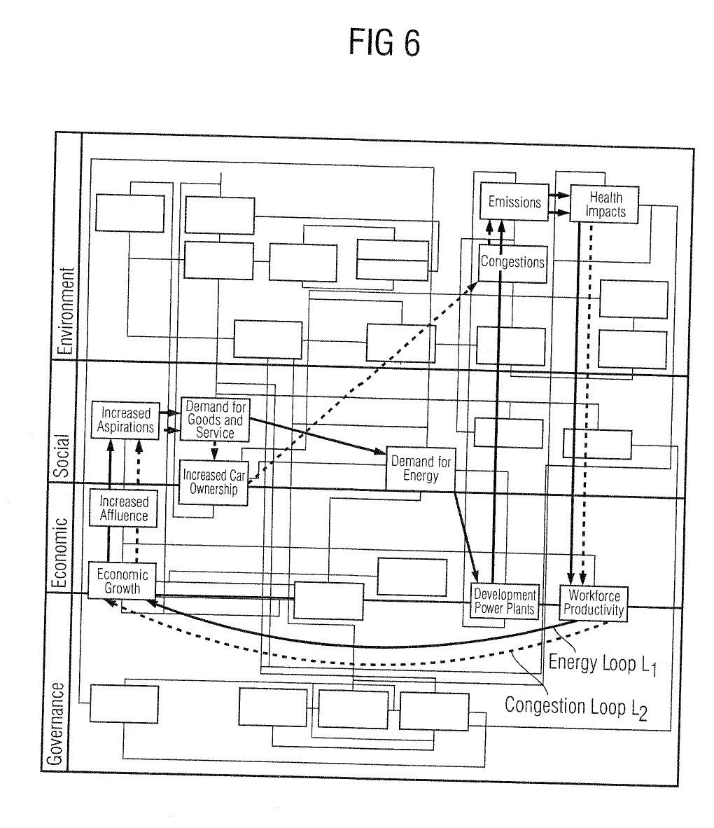

FIG. 6 shows a further example for two dependency loops within a urban development graph UDG as used by the apparatus and method according to the present invention. In the given example, there is an energy loop L₁ and a congestion loop L₂. As can be seen from FIG. 6, some nodes of the urban development factors belong to different loops L. For example, the urban development factor “emissions” belongs to the energy loop L₁ as well as to the congestion loop L₂. As can be seen, increased car ownership increases congestions and as a result emission. Power plants also increase the amount of emissions having a negative impact on the factor “health”.

In a possible embodiment of the method and apparatus according to the present invention, the urban development graph UDG such as shown in FIG. 6 is also displayed to the user on the display 3.

In a possible embodiment of the method and apparatus according to the present invention, the user can see on the display 3 the urban development link matrix UDLM as shown in FIG. 2 corresponding to an urban development graph UDG as shown in FIG. 3 and the sorted dependency loops L in descending order according with the objective function values OF.

In a possible embodiment, the user can select dependency loops of interest which are automatically highlighted in the urban development graph UDG such as shown in FIG. 6.

In a possible embodiment, the user can further change the objective function OF to analyze the impact on the dependency loops L on the urban development graph. Consequently, the method according to the present invention provides a powerful tool for a user for analyzing complex interdependencies of urban development factors f.

It is important that money is invested optimal into the infrastructure of a city. The method according to the present invention allows the user to identify and find dependencies showing the impact of investments on urban development factors.

In a possible embodiment, the method and apparatus according to said invention allows the user to perform simulations by changing the objective functions OF, the urban development factors f or the weighting factors w.

The method and apparatus according to the present invention are adaptable to any weighting schemes and can use any objective function OF.

In a possible embodiment, a computer program for performing the method according to the present invention can be executed by the calculating unit 5 of the apparatus 1. In a possible embodiment, the program is read from a data carrier provided for storing such a computer program.

In an alternative embodiment, the user generates the urban development link matrix UDLM and sends it to a remote server which performs the method according to the present invention. Then, the server sends the results of the analysis back via a network to clients.

In a possible embodiment, the server provides the clients with a list of selectable urban development factors in several categories.

The method and apparatus according to the present invention can be applied for any kind of infrastructure, such as villages, towns, cities, or even the infrastructure of a whole state.

In a possible embodiment of the method according to the present invention, the weighting factors w are not input by experts but calculated on the basis of statistical data stored in a database.

The method and apparatus according to the present invention allows to identify key factors for the development of a community and to generate a macro-model of an urban infrastructure. The method and apparatus according to the present invention facilitates analyzing and planning of urban developments. Any search algorithm for finding dependency loops L within the urban development graph UDG can be employed, such as an evolutional algorithm or the so-called ant algorithm.

1. A method for identifying dependency loops in an urban development graph having nodes each representing an urban development factor,
wherein said nodes are connected to each other via weighted edges describing dependencies between said nodes,
wherein an objective function value is calculated for each loop of said urban development graph and the loops are sorted according to the respective calculated objective function values of said loops.

2. The method according to claim 1,
wherein the calculated objective function values are sorted in a descending order.

3. The method according to claim 1,
wherein said urban development graph is encoded by a urban development link matrix.

4. The method according to claim 1,
wherein urban development graph is formed by a directed graph.

5. The method according to claim 1,
wherein the objective function is selected from a group of predetermined objective functions.

6. A computer program for analyzing dependency loops in an urban development graph having nodes each representing an urban development factor,
wherein said nodes are connected to each other via weighted edges describing dependencies between said nodes,
wherein an objective function is calculated for each loop of said urban development graph and the loops are sorted according to the respective calculated objective function values of said loops.

7. The computer program according to claim 6,
wherein the calculated objective function values are sorted in a descending order.

8. The computer program according to claim 1,
wherein said urban development graph is encoded by an urban development loop matrix.

9. The computer program according to claim 6,
wherein said urban development graph is formed by a directed graph.

10. The computer program according to claim 6,
wherein the objective function is selected from a group of predetermined objective function.

11. A data carrier for storing said computer program according to claim 6.

12. An apparatus for analyzing dependency loops in an urban development graph, each node representing an urban development factor,
wherein said nodes are connected to each other via weighted edges describing dependencies between said nodes,
wherein said apparatus comprises:
(a) a memory for storing an urban development link matrix representing said urban development graph; and
(b) a calculating unit for calculating an objective function value for each loop of said urban development graph and for sorting the respective calculated objective function values of said loops.

13. The apparatus according to claim 12,
wherein the apparatus further comprises input means for inputting urban development factors into an urban development link matrix template displayed on a display of said apparatus.

14. The apparatus according to claim 13,
wherein weighting factors are input via said input means into the urban development link matrix template to generate said urban development link matrix.

15. The apparatus according to claim 13,
wherein the sorted loops and the corresponding calculated object function values are displayed on said display of said apparatus.
